(19) United States
(12) Patent Application Publication
(10) Pub. No.: US 2025/0131587 A1
(43) Pub. Date: Apr. 24, 2025

(54) ASSET CREATION METHOD USING COVARIANCE MATRIX-BASED PARALLEL NETWORK AND APPARATUS FOR THE SAME

(71) Applicant: ELECTRONICS AND TELECOMMUNICATIONS RESEARCH INSTITUTE, Daejeon (KR)

(72) Inventors: Ji-Youn LIM, Daejeon (KR); Won-Joo PARK, Daejeon (KR); Jeong-Woo SON, Daejeon (KR); Alex LEE, Daejeon (KR)

(21) Appl. No.: 18/924,898

(22) Filed: Oct. 23, 2024

(30) Foreign Application Priority Data
Oct. 23, 2023 (KR) 10-2023-0142088

(51) Int. Cl. G06T 7/73; G06T 7/11

(52) U.S. Cl. CPC G06T 7/73; G06T 7/11; G06T 2207/10028; G06T 2207/20084

(57) ABSTRACT

Disclosed herein are an asset creation method using a covariance matrix-based parallel network and an apparatus for the same. The asset creation method includes simultaneously performing segmentation and position information identification on a target object to be assetized from a video received from a user terminal based on a parallel network including a three-dimensional (3D) semantic segmentation network and a Long Short-Term Memory (LSTM) network, and generating a 3D video feature of the target object from results of the segmentation and the position information identification based on a covariance matrix, and creating an asset in conformity with the 3D video feature.

### CROSS REFERENCE TO RELATED APPLICATION

This application claims the benefit of Korean Patent Application No. 10-2023-0142088, filed Oct. 23, 2023, which is hereby incorporated by reference in its entirety into this application.

### BACKGROUND OF THE INVENTION

### 1. Technical Field

The present disclosure relates generally to asset creation technology using a covariance matrix-based parallel network, and more particularly to technology for supporting asset creation to allow a user to efficiently create assets in the metaverse world from his or her real-world collectibles without securing advanced skills and resources for creating three-dimensional (3D) objects.

### 2. Description of the Related Art

Technology for extracting information from 3D videos (or images) has been continuously developed. In particular, in the field of autonomous driving technology, technology for generating geographic information and 3D maps from 3D video data or 3D segmentation technology for recognizing pedestrians or animals has been proposed. Recently, with growing interest in metaverse-related technologies, various technologies related to the creation of 3D metaverse assets have been proposed. With the commercialization of metaverse services, collaborations between high-end fashion brands and the metaverse services have increased, and a new type of consumption behavior pattern that allows the young generations to express themselves has emerged.

Therefore, it can be expected that there will be a demand for technology that allows the user to utilize his or her valuable assets, which are personal collectibles from the real world, or highly-expensive assets acquired in metaverse services, across heterogeneous metaverse platforms with different rendering methods. For example, technologies matching the demand may include technologies that intend to recreate pets in the metaverse world or methods that allow a user's avatar to wear the clothing worn by a protagonist in media such as films.

However, such conventional technology adopts a technique for conversion into a form wearable by the actual user's avatar based on a database in which previously rendered assets are stored, or a scheme for searching for and recommending similar assets.

### PRIOR ART DOCUMENTS

### Patent Documents

(Patent Document 1) Korean Patent Application Publication No. 10-2023-0067469, Date of Publication: May 16, 2023 (Title: Metaverse service operation server to operate the metaverse service that can create its own 3D avatar matching the protagonist of the movie selected by the user in the metaverse environment and the operating method thereof)

### SUMMARY OF THE INVENTION

Accordingly, the present disclosure has been made keeping in mind the above problems occurring in the prior art, and an object of the present disclosure is to extract an accessory or clothing worn by a user in a video and create an asset utilizable in the metaverse world from the result of extraction.

Another object of the present disclosure is to efficiently assetize belongings of a user without securing advanced skills and resources for creating 3D objects.

A further object of the present disclosure is to create a 3D object from an object, the ownership of which is acquired by a user in the real world or an object on a metaverse service and to utilize the 3D object as a digital asset that can be utilized in another form of metaverse service, a Non-fungible token (NFT) service, or the like.

In accordance with an aspect of the present disclosure to accomplish the above objects, there is provided an asset creation method, including simultaneously performing segmentation and position information identification on a target object to be assetized from a video received from a user terminal based on a parallel network including a three-dimensional (3D) semantic segmentation network and a Long Short-Term Memory (LSTM) network; and generating a 3D video feature of the target object from results of the segmentation and the position information identification based on a covariance matrix, and creating an asset in conformity with the 3D video feature.

Creating the asset may include calculating a vector pointing from one point to an additional point based on sequence data extracted from 3D video data of the video.

Calculating the vector may include measuring similarity to the additional point while rotating the 3D video data from the one point at a preset angle using the covariance matrix.

The similarity may be measured to correspond to a weighted sum of Jaccard similarity and cosine similarity.

The similarity may be measured based on embedding of position information and embedding of color information.

Creating the asset may include performing 3D convolution by configuring a loss function based on the similarity.

Calculating the vector may further include performing dimension reduction on a point cloud corresponding to the 3D video data in consideration of a computing resource.

Performing the dimension reduction may include applying mean pooling of 3D convolution to each point.

In accordance with another aspect of the present disclosure to accomplish the above objects, there is provided an asset creation apparatus, including a processor configured to simultaneously perform segmentation and position information identification on a target object to be assetized from a video received from a user terminal based on a parallel network including a three-dimensional (3D) semantic segmentation network and a Long Short-Term Memory (LSTM) network, generate a 3D video feature of the target object from results of the segmentation and the position information identification based on a covariance matrix, and create an asset in conformity with the 3D video feature; and a memory configured to store the video.

The processor may be configured to calculate a vector pointing from one point to an additional point based on sequence data extracted from 3D video data of the video.

The processor may be configured to measure similarity to the additional point while rotating the 3D video data from the one point at a preset angle using the covariance matrix.

The similarity may be measured to correspond to a weighted sum of Jaccard similarity and cosine similarity.

The similarity may be measured based on embedding of position information and embedding of color information.

The processor may be configured to perform 3D convolution by configuring a loss function based on the similarity.

The processor may be configured to perform dimension reduction on a point cloud corresponding to the 3D video data in consideration of a computing resource.

The processor may be configured to apply mean pooling of 3D convolution to each point.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating an asset creation system using a covariance matrix-based parallel network according to an embodiment of the present disclosure;

FIG. 2 is an operation flowchart illustrating an asset creation method using a covariance matrix-based parallel network according to an embodiment of the present disclosure;

FIG. 3 is a diagram illustrating an example of a detailed configuration of an asset creation apparatus according to the present disclosure;

FIG. 4 is a diagram illustrating an example in which the shape of a target to be assetized varies or disappears whenever the posture of a person changes in a video;

FIG. 5 is a diagram illustrating an example in which a vector pointing from one point to another point is calculated based on a point cloud or voxels in a 3D video according to the present disclosure;

FIG. 6 is an operation flowchart illustrating in detail an asset creation process according to an embodiment of the present disclosure; and

FIG. 7 is a diagram illustrating an asset creation apparatus using a covariance matrix-based parallel network according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Hereinafter, embodiments of the present disclosure will be described in detail with reference to the attached drawings.

In assets on 3D video (image) data from the real world or online services, the size of an object desired to be assetized may greatly differ, and the appearance and position of the object continuously change due to the sequential characteristics of the video, thus making it difficult to reliably identify the object.

Therefore, the present disclosure is intended to propose an object extraction or identification method robust to such a problem. That is, the present disclosure proposes a method for extracting a target object desired to be assetized from 3D video data on the real world or online service so as to support 3D object creation so that a user who uses a metaverse service can personally and easily create a 3D object.

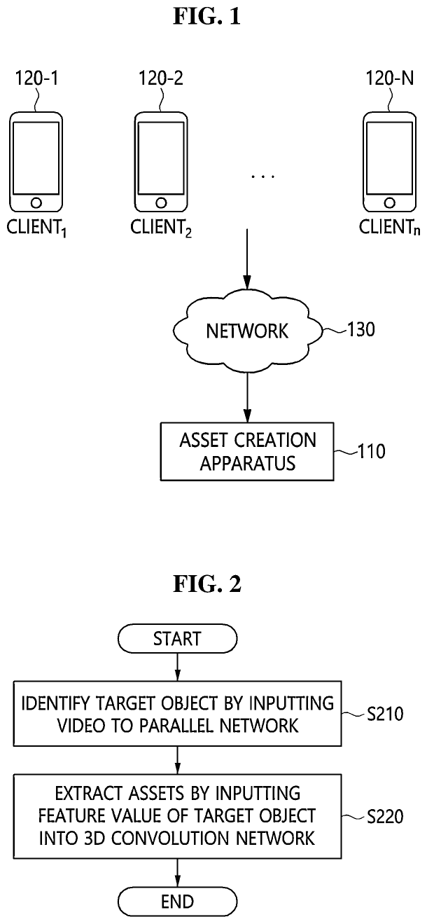

FIG. 1 is a diagram illustrating an asset creation system using a covariance matrix-based parallel network according to an embodiment of the present disclosure.

Referring to FIG. 1, the asset creation system using a covariance matrix-based parallel network according to the embodiment of the present disclosure may include an asset creation apparatus 110, user terminals (clients) 120-1 to 120-N, and a network 130.

The asset creation apparatus 110 simultaneously performs segmentation and position information identification on a target object to be assetized from videos received from the user terminals 120-1 to 120-N based on a parallel network composed of a 3D semantic segmentation network and a Long Short-Term Memory (LSTM) network.

For example, after recording a video using a corresponding one of the user terminals 120-1 to 120-N, the user may transmit the recorded video to the asset creation apparatus 110 over the network 130. Thereafter, the asset creation apparatus 110 may convert the received video into 3D video data such as data in a point cloud format or the like, and then compress the 3D video data.

Further, the asset creation apparatus 110 generates 3D video features of the target object from the results of segmentation and position information identification based on a covariance matrix, and creates assets in conformity with the 3D video features.

Here, a vector pointing from one point to another point may be calculated based on sequence data extracted from the 3D video data of the video.

Here, the similarity to the other point may be measured while the 3D video data is rotated from the one point at a preset angle using the covariance matrix.

Here, the similarity may be measured based on embedding of position information (positional embedding) and embedding of color information (color embedding).

Here, a loss function based on the similarity may be configured to perform 3D convolution.

Here, resource reduction for the point cloud corresponding to the 3D video data may be performed in consideration of computing resources.

In this case, mean pooling of 3D convolution may be applied to each point.

Each of the user terminals 120-1 to 120-N may be a mobile device equipped with a camera, such as a smartphone or a tablet PC, and the video recorded by each device may include depth information to be converted into 3D video data. For example, the depth information may be acquired by a device equipped with a LiDAR sensor, or a dedicated camera (pinhole camera) or the like capable of estimating depth.

The network 130 is a concept embracing all of existing networks that have been used and networks that can be developed in the future. For example, the network may include an IP network that provides high-capacity data transmission/reception services and seamless data services through the Internet Protocol (IP), an All IP network that is an IP network structure that integrates different networks based on IP, etc. Further, the network may be implemented as a combination of one or more networks among a wired network, a Wireless Broadband (WiBro) network, a third generation mobile communication network including Wideband Code Division Multiple Access (WCDMA), a 3.5th generation mobile communication network including a High Speed Downlink Packet Access (HSDPA) network and a Long Term Evolution (LTE) network, a fourth generation mobile communication network including LTE-Advanced, a satellite communication network, and a Wi-Fi network.

By means of this system, accessories worn by a person or parts shown in machines may be accurately segmented for respective frames, and assets may be obtained based on the results of segmentation. Consequently, assets may be identified from 3D videos in which positions, appearance, and shapes are continuously changing.

FIG. 2 is an operation flowchart illustrating an asset creation method using a covariance matrix-based parallel network according to an embodiment of the present disclosure.

Referring to FIG. 2, in the asset creation method using a covariance matrix-based parallel network according to the embodiment of the present disclosure, an asset creation apparatus simultaneously performs segmentation and position information identification on a target object to be assetized from videos received from a user terminal based on a parallel network composed of a 3D semantic segmentation network and a Long Short-Term Memory (LSTM) network at step S210.

In this case, semantic segmentation may be performed on the videos over the 3D semantic segmentation network, and a target object such as a person or a vehicle from whom or which assets are to be additionally extracted may be identified among segments resulting from segmentation.

Here, a dynamic 3D convolutional network may be applied to the target object that becomes the target such as a person or a vehicle so that more sampling is performed on the target object.

In this case, accessories such as a headband, flower decoration on the headband, and earrings worn by a person may appear differently to show different portions or even become invisible in some scenes whenever the posture of the person 410 or 420 changes in the videos, as shown in FIG. 4.

Therefore, the present disclosure may identify the position information of the target object in such a way as to recognize the sequence in which the positions of respective points are changed by applying the Long Short-Term Memory (LSTM) network.

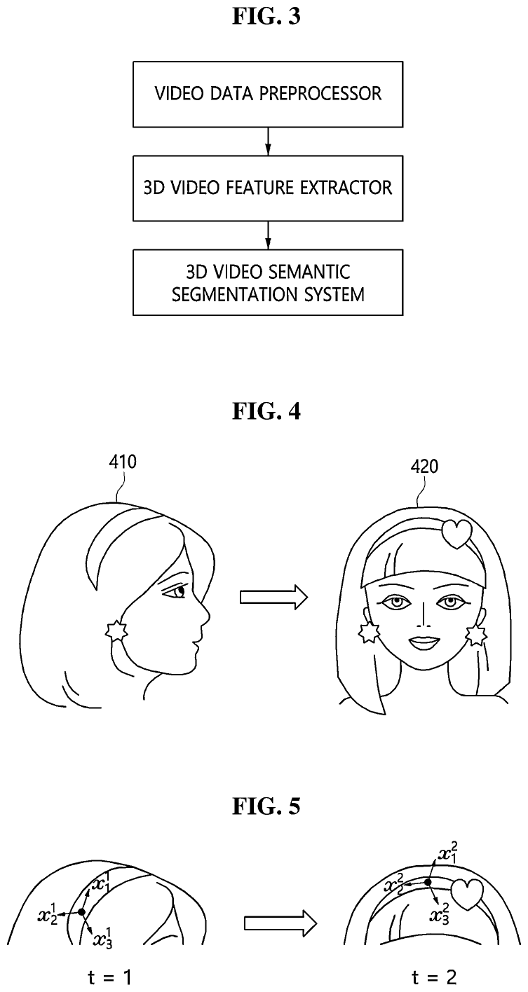

For example, the asset creation apparatus according to the embodiment of the present disclosure may include a video data preprocessor, a 3D video feature extractor, and a 3D video semantic segmentation system, as illustrated in FIG. 3.

When the user terminal records a video and transmits the video to the asset creation apparatus, the video data preprocessor may convert the video into 3D video data in a point cloud format or the like.

In this case, video data including depth information and video data recorded by a normal camera may be distinguished from each other, and preprocessing of video data may be performed on the distinguished video data. That is, for the video recorded by the normal camera, the depth information thereof may be estimated using a deep learning network, and the video may be converted into 3D video data such as in a point cloud format. Further, because the 3D video data including depth information has very large data capacity, an encoder for compressing data capacity may be used to reduce consumption of computer resources.

Furthermore, in the asset creation method using a covariance matrix-based parallel network according to the embodiment of the present disclosure, the asset creation apparatus generates 3D video features of the target object from the results of segmentation and position information identification based on the covariance matrix, and creates assets in conformity with the 3D video features at step S220.

For example, in the present disclosure, features may be extracted from 3D video data, converted into a point cloud format, through a feature extraction algorithm based on the 3D video extractor, illustrated in FIG. 3, and assets may be extracted from the target object in the video by utilizing the extracted features as input values.

Here, the 3D convolutional network may be used to extract assets from respective frames of the video.

Here, a vector pointing from one point to another point may be calculated based on sequence data extracted from the 3D video data of the video.

Here, the similarity to the other point may be measured while the 3D video data is rotated from the one point at a preset angle using the covariance matrix.

Here, the similarity may be measured to correspond to a weighted sum of Jaccard similarity and cosine similarity.

Here, the similarity may be measured based on embedding of position information (positional embedding) and embedding of color information (color embedding).

Here, a loss function based on the similarity may be configured to perform 3D convolution.

Here, dimension reduction for the point cloud corresponding to the 3D video data may be performed in consideration of computing resources.

Here, mean pooling of 3D convolution may be applied to each point.

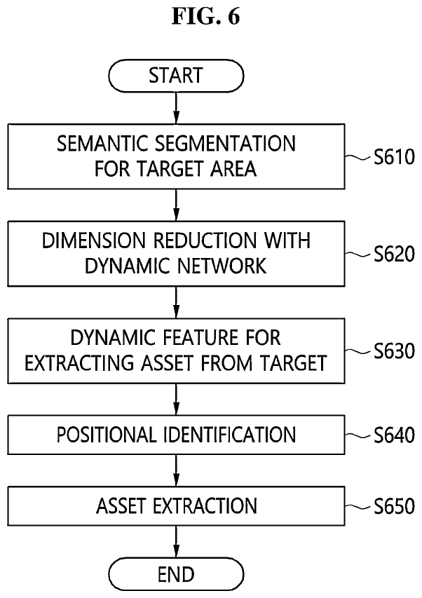

Hereinafter, an asset creation process will be described in detail with reference to FIG. 6.

First, sequence data may be extracted in consideration of the sequence of a video, and a vector pointing from one point to another point may be calculated when the 3D convolutional network is applied at step S610. Here, as shown in FIG. 5, 3D video data may appear in the format of a point cloud or in the form of voxels. Also, each point may include color information such as RGB information, or position information (including depth) in data.

Therefore, the use of all points requires a lot of computing resources, and thus dimension reduction processing needs to be performed at step S620. If there are sufficient computing resources, the dimension reduction process may be skipped.

Here, dimension reduction may be performed on each point using mean pooling or the like of 3D convolution. A target segment may be defined by making the kernel size relatively small, as shown in the following Equation (1) when 3D convolution is applied. Here, as the kernel size, a normalized value may be statistically set in consideration of a standard deviation or the like.

$${Kernel}_{target} \leq {Kernel}_{nontarget} \qquad ( 1 )$$

Thereafter, for the reduced dimension, the similarity to another point may be measured while 3D video data is rotated around one point at a certain angle at step S630. Here, although, in FIG. 5, the 3D video data has been rotated at an angle of 120 degrees, the 3D video data may be rotated by applying various methods such as orthogonal rotation of 90 degrees and rotation of 60 degrees, depending on the computing resources secured by the user.

Here, information about each point may be composed of embedding of position information (i.e., positional embedding) and embedding of color information (i.e., color embedding), as shown in the following Equation (2).

$$\begin{matrix}Positional embedding : ( {x}_{i 1}^{t} , {x}_{i 2}^{t} , {x}_{i 3}^{t} ) , Color embedding : ( {x}_{iR}^{t} , {x}_{iG}^{t} , {x}_{iB}^{t} ) \\ i ∈ \{ 1 , … , P \} , P : total number of reduced points \\ i ∈ \{ 1 , … , T \} , T : total number of time sequence\end{matrix} \qquad ( 2 )$$

The present disclosure may calculate similarity using a covariance matrix in a manner similar to using a covariance matrix in principal component analysis which is one of dimension reduction algorithms.

Here, as shown in the following Equation (3), a weighted sum of Jaccard similarity and cosine similarity may be used. Here, a threshold may be heuristically determined within a statistical range based on the average of weighted sums.

$$\begin{matrix}{f}_{x} = \frac{{\sum }_{{neighbor}^{= 1}}^{{n}_{p}} [ {α}_{J} ( x , {x}_{neighbor} ) + ( 1 - α ) Cosine ( x , {x}_{neighbor} ) ]}{{n}_{p}} \\ {n}_{p} = number of neighbors of point p\end{matrix} \qquad ( 3 )$$

Furthermore, because the position of each point captured from the target object varies with the motion of the target object, the LSTM-based network may be applied, together with the 3D convolutional network, so as to track the motion of the target object and identify the moved point at step S640.

Thereafter, as the similarity becomes greater, it means that the corresponding point indicates a different position, and thus this concept is configured as a loss function to perform 3D convolution, and assets may be extracted from target context in the video by fusing the results of the above-described two networks at step S650.

By means of the asset creation method using a covariance matrix-based parallel network, 3D data may be acquired from a state in which a user wears accessories, clothing or the like without change, and may be assetized.

Further, a 3D object may be created from an object, the ownership of which is acquired by the user in the real world or an object on a metaverse service, and may be utilized as digital assets in another type of metaverse service, NFT service, etc.

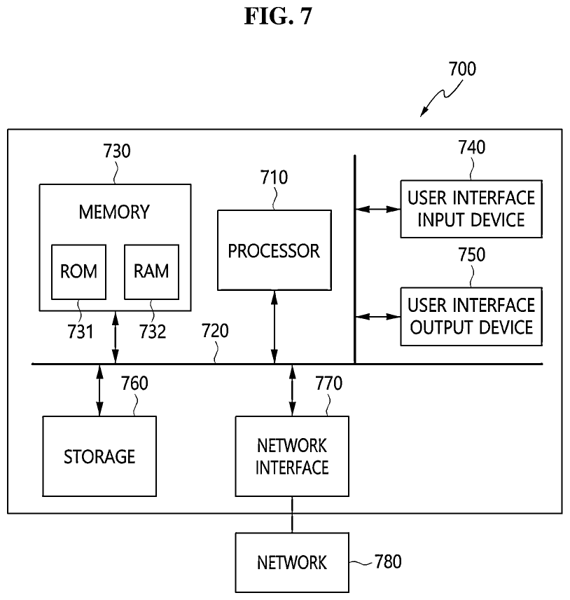

FIG. 7 is a diagram illustrating an asset creation apparatus using a covariance matrix-based parallel network according to an embodiment of the present disclosure.

Referring to FIG. 7, an asset creation apparatus using a covariance matrix-based parallel network according to an embodiment of the present disclosure may be implemented in a computer system such as a computer-readable storage medium. As shown in FIG. 7, a computer system 700 may include one or more processors 710, memory 730, a user interface input device 740, a user interface output device 750, and storage 760, which communicate with each other through a bus 720. The computer system 700 may further include a network interface 770 connected to a network 780. Each processor 710 may be a Central Processing Unit (CPU) or a semiconductor device for executing programs or processing instructions stored in the memory 730 or the storage 760. Each of the memory 730 and the storage 760 may be any of various types of volatile or nonvolatile storage media. For example, the memory 730 may include Read-Only Memory (ROM) 731 or Random Access Memory (RAM) 732.

Therefore, the embodiment of the present disclosure may be implemented as a non-transitory computer-readable medium in which a computer-implemented method or computer-executable instructions are stored. When the computer-readable instructions are executed by the processor, the computer-readable instructions may perform the method according to at least one aspect of the present disclosure.

The processor 710 simultaneously performs segmentation and position information identification on a target object to be assetized from a video received from a user terminal based on a parallel network composed of a 3D semantic segmentation network and a Long-Short Term Memory (LSTM) network.

In this case, semantic segmentation may be performed on the videos over the 3D semantic segmentation network, and a target object such as a person or a vehicle from whom or which assets are to be additionally extracted may be identified among segments resulting from segmentation.

Here, a dynamic 3D convolutional network may be applied to the target object that becomes the target such as a person or a vehicle so that more sampling is performed on the target object.

In this case, accessories such as a headband, flower decoration on the headband, and earrings worn by a person may appear differently to show different portions or even become invisible in some scenes whenever the posture of the person 410 or 420 changes in the videos, as shown in FIG. 4.

Therefore, the present disclosure may identify the position information of the target object in such a way as to recognize the sequence in which the positions of respective points are changed by applying the Long Short-Term Memory (LSTM) network.

For example, the asset creation apparatus according to the embodiment of the present disclosure may include a video data preprocessor, a 3D video feature extractor, and a 3D video semantic segmentation system, as illustrated in FIG. 3.

When the user terminal records a video and transmits the video to the asset creation apparatus, the video data preprocessor may convert the video into 3D video in a point cloud format or the like.

In this case, video data including depth information and video data recorded by a normal camera may be distinguished from each other, and preprocessing of video data may be performed on the distinguished video data. That is, for the video recorded by the normal camera, the depth information thereof may be estimated using a deep learning network, and the video may be converted into 3D video data such as in a point cloud format. Further, because the 3D video data including depth information has very large data capacity, an encoder for compressing data capacity may be used to reduce consumption of computer resources.

Further, the processor 710 generates 3D video features of the target object from the results of segmentation and position information identification based on a covariance matrix, and creates assets in conformity with the 3D video features.

For example, in the present disclosure, the features may be extracted from 3D video data, converted into a point cloud format, through a feature extraction algorithm based on the 3D video extractor, illustrated in FIG. 3, and assets may be extracted from the target object in the video by utilizing the extracted features as input values.

Here, the 3D convolutional network may be used to extract assets from respective frames of the video.

Further, the processor 710 may calculate a vector pointing from one point to another point based on sequence data extracted from the 3D video data of the video.

Here, the similarity to the other point may be measured while the 3D video data is rotated from the one point at a preset angle using the covariance matrix.

Here, the similarity may be measured to correspond to a weighted sum of Jaccard similarity and cosine similarity.

Here, the similarity may be measured based on embedding of position information (positional embedding) and embedding of color information (color embedding).

Furthermore, the processor 710 may configure a loss function based on the similarity to perform 3D convolution.

In addition, the processor 710 may perform dimension reduction for the point cloud corresponding to the 3D video data in consideration of computing resources.

Here, mean pooling of 3D convolution may be applied to each point.

In an embodiment, the memory 730 may be configured independently of the asset creation apparatus to support functions for asset creation. Here, the memory 730 may function as separate mass storage, and may include a control function for performing operations.

In an embodiment, the memory may be a computer-readable medium. In an embodiment, the memory may be a volatile memory unit, and in another embodiment, the memory may be a nonvolatile memory unit. In an embodiment, a storage device may be a computer-readable medium. In various different embodiments, the storage device may be, for example, a hard disk device, an optical disk device, or another type of mass storage device.

By utilizing the asset creation apparatus using a covariance matrix-based parallel network, 3D data may be acquired from a state in which a user wears accessories, clothing or the like without change, and may be assetized.

Further, a 3D object may be created from an object, the ownership of which is acquired by the user in the real world or an object on a metaverse service, and may be utilized as digital assets in another type of metaverse service, NFT service, etc.

According to the present disclosure, an accessory or clothing worn by a user in a video may be extracted, and an asset utilizable in the metaverse world may be created from the result of extraction.

Further, the present disclosure may efficiently assetize belongings of a user without securing advanced skills and resources for creating 3D objects.

Furthermore, the present disclosure may create a 3D object from an object, the ownership of which is acquired by a user in the real world or an object on a metaverse service, and may utilize the 3D object as a digital asset that can be utilized in another form of metaverse service, a Non-fungible token (NFT) service, or the like.

As described above, in the asset creation method using a covariance matrix-based parallel network and the apparatus for the same according to the present disclosure, the configurations and schemes in the above-described embodiments are not limitedly applied, and some or all of the above embodiments can be selectively combined and configured so that various modifications are possible.

What is claimed is:

1. An asset creation method, comprising:
simultaneously performing segmentation and position information identification on a target object to be assetized from a video received from a user terminal based on a parallel network including a three-dimensional (3D) semantic segmentation network and a Long Short-Term Memory (LSTM) network; and
generating a 3D video feature of the target object from results of the segmentation and the position information identification based on a covariance matrix, and creating an asset in conformity with the 3D video feature.

2. The asset creation method of claim 1, wherein creating the asset comprises:
calculating a vector pointing from one point to an additional point based on sequence data extracted from 3D video data of the video.

3. The asset creation method of claim 2, wherein calculating the vector comprises:
measuring similarity to the additional point while rotating the 3D video data from the one point at a preset angle using the covariance matrix.

4. The asset creation method of claim 3, wherein the similarity is measured to correspond to a weighted sum of Jaccard similarity and cosine similarity.

5. The asset creation method of claim 3, wherein the similarity is measured based on embedding of position information and embedding of color information.

6. The asset creation method of claim 3, wherein creating the asset further comprises:
performing 3D convolution by configuring a loss function based on the similarity.

7. The asset creation method of claim 3, wherein calculating the vector further comprises:
performing dimension reduction on a point cloud corresponding to the 3D video data in consideration of a computing resource.

8. The asset creation method of claim 7, wherein performing the dimension reduction comprises:
applying mean pooling of 3D convolution to each point.

9. An asset creation apparatus, comprising:
a processor configured to simultaneously perform segmentation and position information identification on a target object to be assetized from a video received from a user terminal based on a parallel network including a three-dimensional (3D) semantic segmentation network and a Long Short-Term Memory (LSTM) network, generate a 3D video feature of the target object from results of the segmentation and the position information identification based on a covariance matrix, and create an asset in conformity with the 3D video feature; and
a memory configured to store the video.

10. The asset creation apparatus of claim 9, wherein the processor is configured to calculate a vector pointing from one point to an additional point based on sequence data extracted from 3D video data of the video.

11. The asset creation apparatus of claim 10, wherein the processor is configured to measure similarity to the additional point while rotating the 3D video data from the one point at a preset angle using the covariance matrix.

12. The asset creation apparatus of claim 11, wherein the similarity is measured to correspond to a weighted sum of Jaccard similarity and cosine similarity.

13. The asset creation apparatus of claim 11, wherein the similarity is measured based on embedding of position information and embedding of color information.

14. The asset creation apparatus of claim 11, wherein the processor is configured to perform 3D convolution by configuring a loss function based on the similarity.

15. The asset creation apparatus of claim 11, wherein the processor is configured to perform dimension reduction on a point cloud corresponding to the 3D video data in consideration of a computing resource.

16. The asset creation apparatus of claim 15, wherein the processor is configured to apply mean pooling of 3D convolution to each point.
